(19) United States
(12) Patent Application Publication
(10) Pub. No.: US 2014/0180777 A1
(43) Pub. Date: Jun. 26, 2014

(54) METHOD AND APPARATUS FOR PAIRING OF A POINT OF SALE SYSTEM AND MOBILE DEVICE

(71) Applicants: Afshin MOSHREFI, Newburyport, MA (US); Farshid Mostoufi, Alpharetta, GA (US); Nader Gharachorloo, Ossining, NY (US)

(72) Inventors: Afshin MOSHREFI, Newburyport, MA (US); Farshid Mostoufi, Alpharetta, GA (US); Nader Gharachorloo, Ossining, NY (US)

(73) Assignee: Verizon Patent and Licensing, Inc., Basking Ridge, NJ (US)

(21) Appl. No.: 13/725,959

(22) Filed: Dec. 21, 2012

(51) Int. Cl. G06Q 20/32

(52) U.S. Cl. CPC G06Q 20/3224
USPC 705/14.4; 705/21

(57) ABSTRACT

A method and apparatus for improved approaches for pairing of a POS system and mobile device is described. The method includes: determining, by a POS system, a proximity of a physical location of a mobile device to an access point associated with the POS system, wherein the mobile device is configured to connect to the access point and to initiate establishment of a communication session over a service provider network; initiating a link, via the access point, between the mobile device and the POS system based on the determined proximity; receiving, via the link, an indication of an item that includes a good, a service, or a combination thereof; determining, by the POS system, item information for the item based on the indication; and transmitting, via the link, the item information to the mobile device.

### BACKGROUND INFORMATION

Networking technologies offer users the convenience of communicating across vast distances that are easy to use, secure and convenient to the user. Despite the availability of these capabilities, particularly with respect to mobile devices, traditional point of sale (POS) systems frequently offer limited information, such as an item price, and aggregated price for multiple items, and typically present such information at the end of a user's shopping experience. For example, users of traditional POS systems (e.g., shoppers) typically collect multiple items and present the items at a POS dedicated terminal of a retailer. Once the items are processed, the POS dedicated terminal may only present the user with an item price for each item and a total amount due.

Therefore, there is a need for approaches for POS systems to better integrate with users' mobile devices.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a communication system capable of presenting item information before a checkout process, according to various embodiments;

FIG. 2 is a diagram of the components of a cloud based POS platform, according to one embodiment;

FIG. 3 is a flowchart of a process for synchronizing item information between a cloud based POS platform and a mobile device, according to one embodiment;

FIG. 4 is a flowchart of a process for determining item information before a checkout process on a cloud based platform, according to one embodiment;

FIG. 5 is a flowchart of a process for accessing services provided by a cloud based POS platform on a mobile device, according to one embodiment;

FIG. 6 is an illustration of one embodiment of a mobile device presenting a coupon for an item based on item information determined by a cloud based POS platform, according to one embodiment;

FIG. 7 is an illustration of one embodiment of a mobile device presenting advertisements for an item using a cloud based POS platform, according to one embodiment;

FIG. 8 is an illustration of one embodiment of a mobile device presenting prices for items at two retailers using a cloud based POS platform, according to one embodiment;

FIG. 9 is an illustration of one embodiment of a mobile device presenting a query result for an item using a cloud based POS platform, according to one embodiment;

FIG. 10 is an illustration of one embodiment of a mobile device presenting an index using a cloud based POS platform, according to one embodiment;

FIG. 11 is an illustration of one embodiment of a mobile device presenting an availability of an item using a cloud based POS platform, according to one embodiment;

FIG. 12 is a diagram of a computer system that can be used to implement various exemplary embodiments;

FIG. 13 is a diagram of a chip set that can be used to implement various exemplary embodiments; and

FIG. 14 is a diagram of a mobile device configured to facilitate various exemplary embodiments.

### DESCRIPTION OF THE PREFERRED EMBODIMENT

A preferred method and system for presenting item information on a mobile device before a checkout process using a POS system is described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

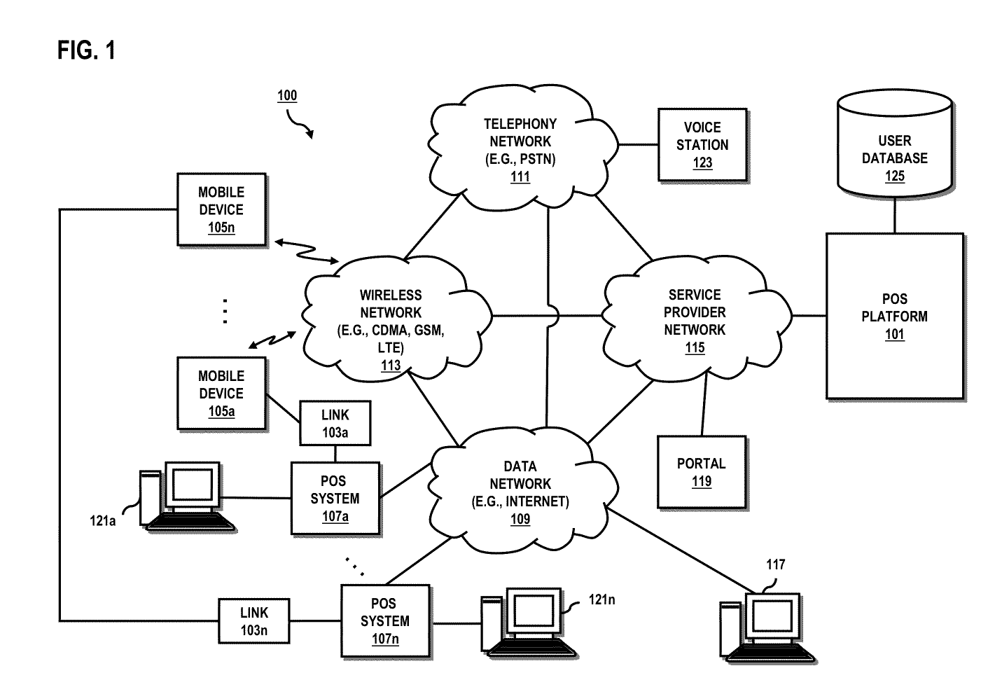

FIG. 1 is a diagram of a communication system capable of presenting item information before a checkout process, according to various embodiments. For illustrative purposes, system 100 is described with respect to a cloud based POS platform (platform) 101. In this example, the platform 101 is configured to establish a link 103 between mobile devices 105 and POS system 107. In one embodiment, link 103 is established by pairing mobile devices 105 and POS systems 107 using, for example, BLUETOOTH. The platform 101 determines item information (e.g., a price for the item, an availability of the item, related coupons, advertisements, item type, etc.) for items detected by mobile devices 105 using POS systems 107. The item information may be presented on mobile devices 105 over one or more networks (e.g., data network 109, telephony network 111, wireless network 113, service provider network 115, etc.) In this manner, the platform 101 is configured to present item information before a “checkout process.”

As used herein a link (e.g., 103) may be any form of communication using two devices. In one embodiment a link utilizes a near field communication (NFC), for instance, BLUETOOTH, WIFI, WIMAX, and the like. In another embodiment, a link utilizes a secure tunneling protocol to establish a secure path through data network 109 and/or wireless network 113. Additionally, a link may be established using auto-paring technologies, such as ANDROID BEAM. Links 103 may connect multiple POS systems 107 to one of the mobile devices 105, connect multiple mobile devices 105 to one of the POS systems 107, and connect multiple devices 105 to multiple POS systems 107. For instance, mobile device 105a may establish a link 103a to POS system 107a and a link (not shown) to POS system 107b. Likewise, POS system 107a may establish a link 103a to mobile device 105a and a link (not shown) to mobile device 105b (not shown).

In certain embodiments, users (e.g., retail employees, customers) may utilize a computing device 117 (e.g., laptop, desktop, web appliance, netbook, etc.) to access platform 101 via service provider portal 119. Service provider portal 119 provides, for example, a web-based user interface to allow users to access the services of platform 101.

According to one embodiment, a cloud based POS service may be part of managed services supplied by a service provider (and/or a POS system provider) as a hosted or subscription-based service made available to users of the mobile devices 105 through a service provider network 115. As shown, platform 101 may be a part of or connected to the service provider network 115. According to another embodiment, at least a portion of platform 101 may be included within or connected to the mobile devices 105.

As mentioned, users (e.g., customers) are frequently faced with POS systems that merely utilize traditional cash registers and/or dedicated POS terminals 121 that provide only a price for items (e.g., goods and/or services) at an end (e.g., checkout) of a shopping experience. However, communication technologies have continued to expand in capabilities, and thus more and more customers have access to mobile devices 105 having hardware capabilities enabling functionalities such as an image capture feature (e.g., camera 1403), radio frequency identification (RFID) reader, data connectivity, and a display (e.g., LCD, pico-projector, etc.).

To address this issue, the system 100 of FIG. 1 introduces the capability establish a link 103 connecting mobile devices 105 to POS systems 107. Further, platform 101 (or mobile device 105) may be configured to determine a POS system 107 with which to establish a link 103. By way of example, when a customer enters a retail location, platform 101 determines POS system 107a to be associated with the retail location and initiates an invitation to establish link 103a between POS system 107a and the customer's mobile device 105a. Once the mobile device 105a has established link 103a to POS system 107a, the customer may then use functionalities available on mobile device 105a that may not be available in traditional POS systems. For example, mobile device 105a, having a link 103a established with the POS system 107a, may present relevant coupons or sales before checkout, recommend items, provide a real time shopping basked comparison, initiate a web based search for a receipt line item, and present an availability of items at another store location. In another example, the customer may use the mobile device 105a, having a link 103a with POS system 107a, to authorize a payment for items scanned by a barcode reader on mobile device 105a. In yet another example, the customer is enabled to generate a home inventory using platform 101 which accesses transactions (e.g., sales receipts) from POS systems 107a and 107b. Platform 101 may also be configured to post a record of a transaction or index (e.g., sales receipt) from, POS system 107a (and 107b) on a social networking website.

As used herein, mobile devices 105 may be any type of mobile terminal including a mobile handset, mobile station, mobile unit, multimedia computer, multimedia tablet, communicator, netbook, Personal Digital Assistants (PDAs), smartphone, media receiver, etc. It is also contemplated that the mobile devices 105 may support any type of interface for supporting the presentment or exchange of data. In addition, mobile devices 105 may facilitate various input means for receiving and generating information, including touch screen capability, keyboard and keypad data entry, voice-based input mechanisms, accelerometer (e.g., shaking the mobile device 105), and the like. Any known and future implementations of mobile devices 105 are applicable. It is noted that, in certain embodiments, the mobile devices 105 may be configured to transmit information (e.g., audio signals, words, address, etc.) using a variety of technologies—e.g., NFC, BLUETOOTH, infrared, etc. Also, connectivity may be provided via a wireless local area network (LAN). By way of example, a group of mobile devices 105 may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each mobile device 105, e.g., IP addresses that are accessible to devices connected to the service provider network 115 as facilitated via a router.

As used herein, POS system 107 may be any type electronic system configured to process transaction for a purchase of items, such as goods, services, or a combination thereof. The POS system 107 may be connected to the any one of the one or more networks, and may be connected (and controlled) by service provider network 115 (not shown), by platform 101 (not shown), or by a party outside of the one or more networks, e.g., 107a, and 107b.

In some embodiments, platform 101, the mobile devices 105, and other elements of the system 100 may be configured to communicate via the service provider network 115. According to certain embodiments, one or more networks, such as the data network 109, the telephony network 111, and/or the wireless network 113, may interact with the service provider network 115. The networks 109-115 may be any suitable wireline and/or wireless network, and be managed by one or more service providers. For example, the data network 109 may be any local area network (LAN), metropolitan area network (MAN), wide area network (WAN), the Internet, or any other suitable packet-switched network, such as a commercially owned, proprietary packet-switched network, such as a proprietary cable or fiber-optic network. For example, computing device 117 may be any suitable computing device, such as a VoIP phone, skinny client control protocol (SCCP) phone, session initiation protocol (SIP) phone, IP phone, personal computer, softphone, workstation, terminal, server, etc. The telephony network 111 may include a circuit-switched network, such as the public switched telephone network (PSTN), an integrated services digital network (ISDN), a private branch exchange (PBX), or other like network. For instance, voice station 123 may be any suitable plain old telephone service (POTS) device, facsimile machine, etc. Meanwhile, the wireless network 113 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like.

Although depicted as separate entities, the networks 109-115 may be completely or partially contained within one another, or may embody one or more of the aforementioned infrastructures. For instance, the service provider network 115 may embody circuit-switched and/or packet-switched networks that include facilities to provide for transport of circuit-switched and/or packet-based communications. It is further contemplated that the networks 109-115 may include components and facilities to provide for signaling and/or bearer communications between the various components or facilities of the system 100. In this manner, the networks 109-115 may embody or include portions of a signaling system 7 (SS7) network, Internet protocol multimedia subsystem (IMS), or other suitable infrastructure to support control and signaling functions.

In certain embodiments, platform 101 may include or have access to user profiles in a user database 125. A user profile may include an index of items purchased along with item information, such as a price paid, return information, (extended) warranty information, coupons, recalls, upgrades, repairs, etc. Additionally, a profile may be associated with a user name, mobile device number (MDN), loyalty card number (e.g., customer card), e-mail, credit card information, and the like. The index may be real time and indicate items purchased from multiple retailers (e.g., using multiple POS systems 107).

While specific reference will be made thereto, it is contemplated that the system 100 may embody many forms and include multiple and/or alternative components and facilities.

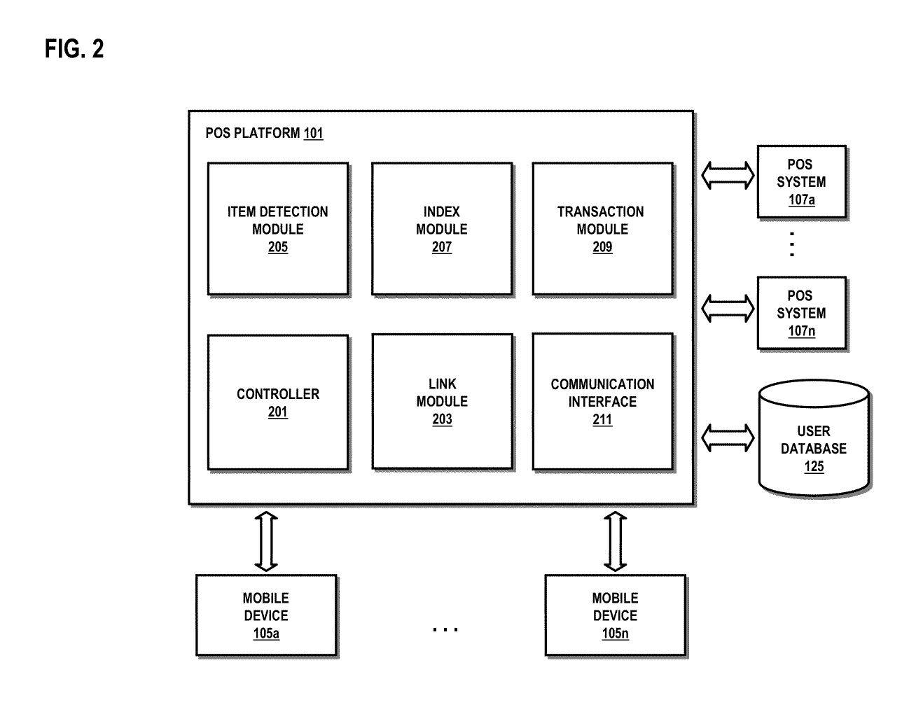

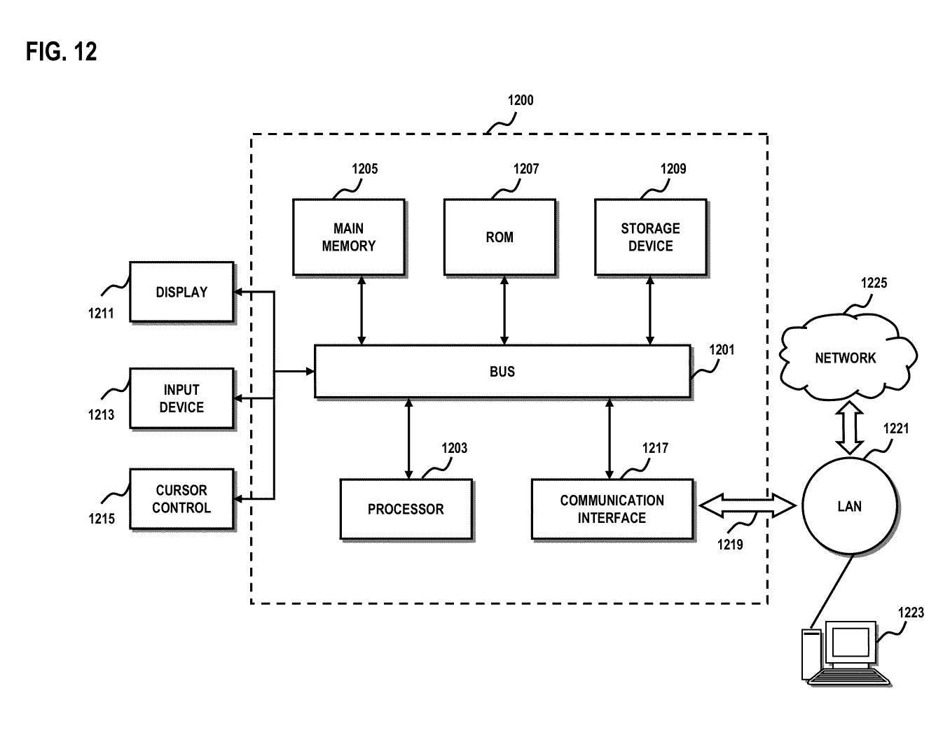

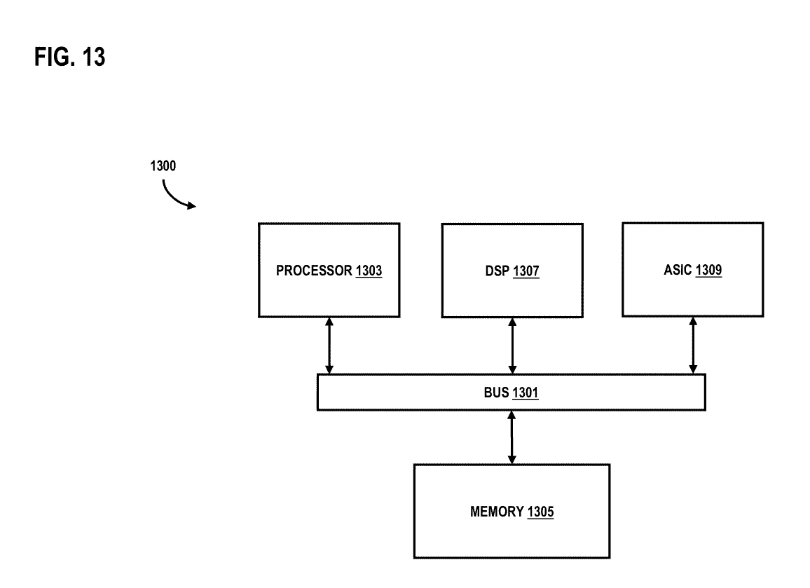

FIG. 2 is a diagram of the components of platform 101, according to one embodiment. The platform 101 may comprise computing hardware (such as described with respect to FIGS. 12 and 13), as well as include one or more components configured to execute the processes described herein for presenting item information before a checkout process. It is contemplated that the functions of these components may be combined in one or more components or performed by other components of equivalent functionality. In one implementation, platform 101 includes a controller 201, link module 203, item detection module 205, index module 207, transaction module 209, and communication interface 211.

The controller 201 may execute at least one algorithm for executing functions of platform 101. For example, the controller 201 may interact with the communication interface 211 to establish a link 103. The controller 201 may then interact with the mobile devices 105 and POS systems 107 to cause, for instance, item detection module 205 to detect items, index module 207 to generate an index of item information for detected items, and transaction module 209 to process a payment for detected items.

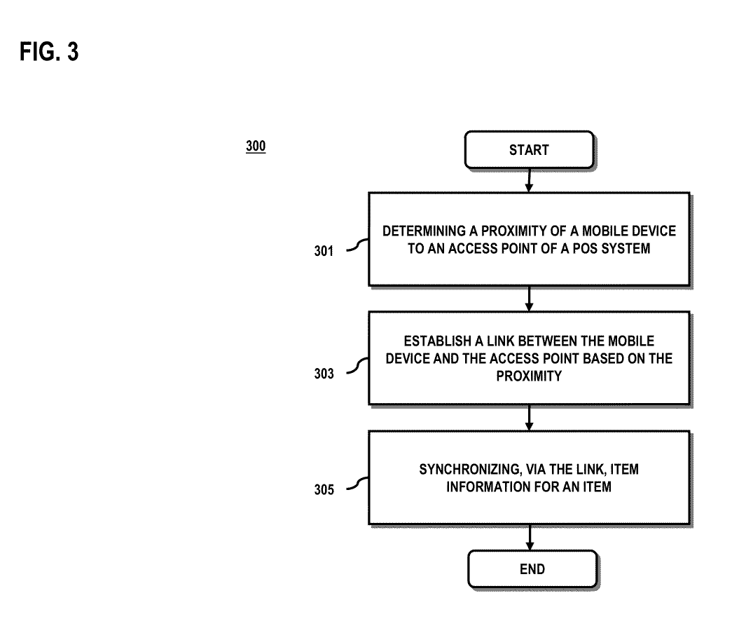

The link module 203 may establish a link between one or more mobile devices 105 with one or more POS systems 107. By way of example, the link module 203 establishes link 103a from mobile device 105a to an access point of POS system 107a by pairing mobile device 105a to the access point of POS system 107a using a BLUETOOTH protocol. As discussed with respect to FIG. 3, the link module 203 may initiate an establishing of links 103 based on a determination of proximity of mobile devices 105 to access points of a POS systems 107. In one embodiment, the link module 203 creates an encrypted connection using, for example, a WIFI or BLUETOOTH protocol. Additionally, a decryption key may be provided using another signal and/or protocol, for instance, an e-mail, sent via data networks 109, an SMS text, sent via wireless network 113, and the like.

The item detection module 205 may identify item information associated with an item. In one embodiment, the detection module 205 receives an image (e.g., barcode) of an item and accesses a log (not shown) to determine item information. In another embodiment, the detection module 205 receives an electronic token indicating an item and requests, via communication interface 211, item information from POS systems 107 using the electronic token.

Index module 207 may determine, generate, and modify an index stored in database, for example, user database 125. In one embodiment, the index module 207 receives a sales receipt of a transaction completed by transaction module 209, and modifies an index in the user database 125 to include items of the sales receipt along with corresponding item information. Additionally, index module 207 may determine and initiate a presentation of (part of) an index stored in the user database 125 on, for example, mobile device 105, computing device 117, a terminal (e.g., 121) of POS system 107, and the like. The index module 207 may initiate a presentation of an index utilizing, for example, portal 119 or a social networking platform. In one embodiment, an index is stored by index module 207 in user database 125 without an input by a user. In another embodiment, mobile device 105a detects an input indicating permission to post (part of) an index on a social networking platform, and index module 207 initiates a storing (and presentation) of the index on the social networking platform.

Transaction module 209 may determine a price for items in (part of) an index and initiate a payment of the price. For example, the transaction module 209 receives a price from index module 207 for one or more items and an indication of a user, and accesses user database 125 to determine payment (e.g., credit card information) associated with the indicated user. Additionally, the transaction module 209 may request user authentication (e.g., a pin number) to process a payment. In another example, the transaction module 209 initiates a transmission on the link 103 indicating the items, the user, and an authorization of payment to POS systems 107 and the POS systems process payment.

The platform 101 may further include a communication interface 211 to communicate with other components of platform 101, the mobile devices 105, POS servers 107, and other components of the system 100. The communication interface 211 may include multiple means of communication. For example, the communication interface 211 may be able to communicate via link 103, over short message service (SMS), multimedia messaging service (MMS), internet protocol, instant messaging, voice sessions (e.g., via a phone network), email, NFC, QR code, or other types of communication. Additionally, communication interface 211 may include a web portal (e.g., service provider portal 119) accessible by, for example, mobile device 105, POS terminals 121, computing device 117, and the like.

It is contemplated that to prevent unauthorized access, platform 101 may include an authentication identifier when transmitting signals to and from mobile devices 105 and to and from POS systems 107. For instance, control messages may be encrypted, either symmetrically or asymmetrically, such that a hash value can be utilized to authenticate received control signals, as well as ensure that those signals have not been impermissibly alerted in transit. As such, communications between the mobile devices 105 and platform 101 and between POS systems 107 and platform 101 may include various identifiers, keys, random numbers, random handshakes, digital signatures, and the like.

FIG. 3 is a flowchart of a process for synchronizing item information between a POS system and a mobile device, according to one embodiment. For illustrative purpose, process 300 is described with respect to the systems of FIGS. 1 and 2. It is noted that the steps of process 300 may be performed in any suitable order, as well as combined or separated in any suitable manner. The process 300 may be performed, for example, by platform 101, mobile devices 105, POS systems 107, or a combination thereof.

In step 301, the link module 203 determines a proximity of a mobile device to an access point of a POS system. The initiation of the determination of proximity may be using any of the means described with respect to the communication interface 211, and may include any information indicating a request to establish a link 103, for example, an input into a user interface of the mobile device 105a, a reception of a request received at mobile device 105a, and the like. The proximity may then be determined, for example, by comparing a geolocation of mobile device 105a and a geolocation of an access point of POS system 107a. In another example, the proximity is determined by reception of a communication transmitted by an access point of POS system 107a and received by mobile device 105a. In yet another example, the proximity is determined by a detection of a user input into mobile device 105a indicating proximity to POS system 107a.

Once the link module 203 determines the proximity, link module 203 establishes, as in step 303, link 103a between the mobile device 105a and access point for POS system 107a based on the proximity. For example, link module 203 may pair a mobile device 105a using, for instance WIFI (or BLUETOOTH) protocol, to an access point of POS system 107a. Additionally or alternatively, link module 203 initiates a secure path to carry data, for example, by use of a tunneling protocol, between mobile device 105a and 107a. For instance, the mobile device 105a may, using a tunneling protocol, may exchange data with POS system 107a via, for instance, the WIFI access point for the POS system 107a, data network 109, wireless network 113, and the like.

Next, the item detection module 205, index module 207, transaction module 209, or a combination thereof, synchronizes, as in step 305, via the link 103, item information for an item. For example, item detection module 205 may determine a universal product (UPC) code for an item in an image captured by mobile device 105a and initiate a transmission of the UPC from the mobile device 105a to the POS system 107a and/or from the POS system 107 to the mobile device 105a. In another example, index module 207 generates an index including a unique item name and corresponding price for each item in the index, and initiates a transmission of the item names and/or corresponding prices from the mobile device 105a to the POS system 107a and/or from the POS system 107 to the mobile device 105a. In yet another example, transaction module 209 initiates an encrypted transmission from mobile device 105a to POS system 107a indicating an authorization code sequence to charge a price to a user and payment information, such as a credit card number, bank account number, service provider account number, and the like.

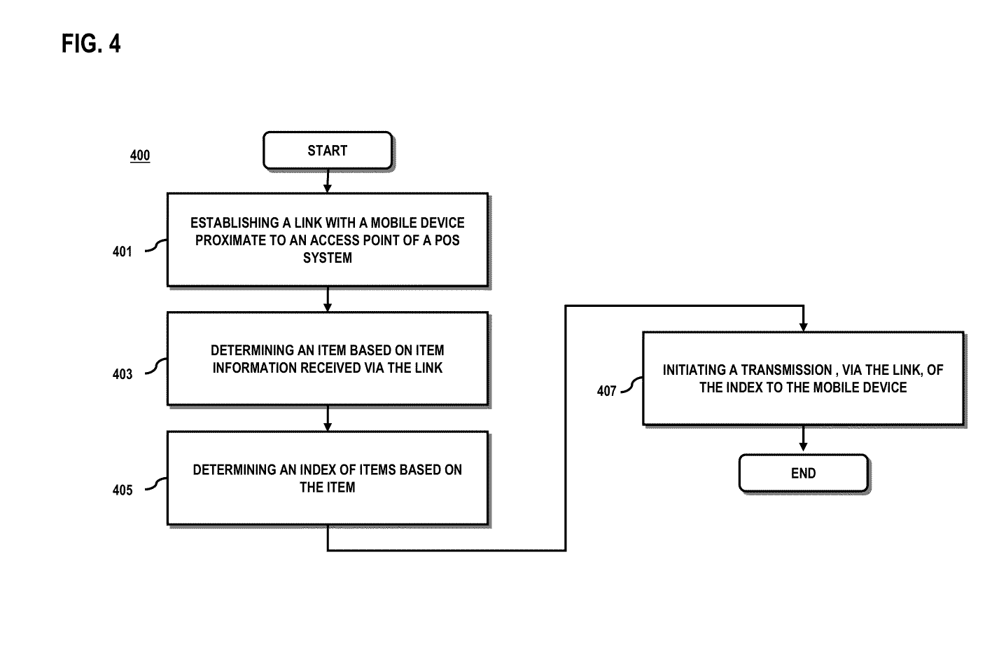

FIG. 4 is a flowchart of a process for determining item information before a checkout process utilizing a cloud based platform, according to one embodiment. For illustrative purpose, process 400 is described with respect to the systems of FIGS. 1 and 2. The steps of process 400 may be performed in any suitable order, as well as combined or separated in any suitable manner. The process 400 may be performed, for example, by platform 101.

In step 401, the link module 203 establishes a link with a mobile device proximate to an access point of a POS system. For example, the link module 203 may transmit, over data network 109, a SMS message (or e-mail) indicating a WIFI or BLUETOOTH login credentials to an access POS system 107a using mobile device 105a. Additionally, once mobile device 105a is within a range of an access point for POS system 107a, a link 103a connecting mobile device 105a to POS system 107a may be established using the WIFI or BLUETOOTH login credentials. In another example, mobile device 105a requests to connect to a WIFI access point of POS system 107a and platform 101 directs a browser of mobile device 105a to the portal 119, where a user can create and/or indicate a user account to initiate link 103a.

The item detection module 205 then determines, as in step 403, an item based on item information received via the link 103. In one embodiment, item detection module 205 determines an item code proprietary to POS system 107a by looking up a stock-keeping unit (SKU) code received from mobile device 105a in a log (not shown) for POS system 107a. In another embodiment, item detection module 205 determines an item by matching an image received from mobile device 105 with an image predetermined to corresponding to the item. Once the item is determined, the index module 207, determines, as in step 405, an index of items based on the item. For example, the index module 207 may include in the index a product code (e.g., SKU, UPC) and corresponding price for each item determined while mobile device 105a is proximate to POS system 107a. In another embodiment, index module 207 includes a name indicating each item purchased from POS system 107b along with, for example, warranty information, exchange dates, return by dates, recalls, repairs, and the like corresponding to each item. As previously noted, the index may be presented on, for instance, an application provisioned on mobile device 105, a browser via portal 119 and a social networking web site on, for example, mobile devices 105 or computing device 117. The index may then be transmitted, as in step 407, via the link 103, from, for instance, POS system 107a to mobile device 105a. The initiation of the determination of transmission, via the link 103, of the index to the mobile device 105a, may be using any of the means described with respect to the communication interface 211.

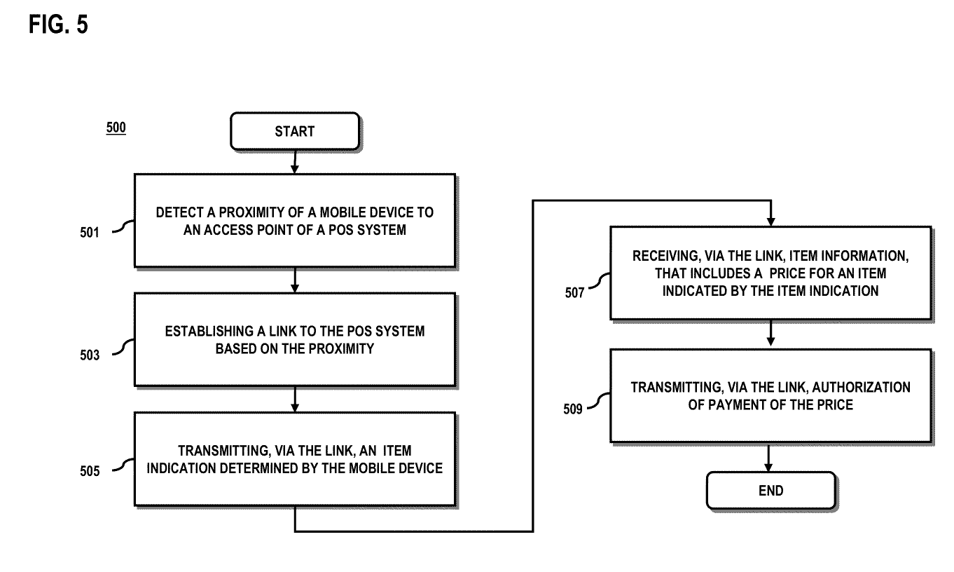

FIG. 5 is a flowchart of a process for accessing services provided by a cloud based POS platform on a mobile device, according to one embodiment. For illustrative purpose, process 500 is described with respect to the systems of FIGS. 1 and 2. It is noted that the steps of process 500 may be performed in any suitable order, as well as combined or separated in any suitable manner. The process 500 may be performed, for example, mobile devices 105, and mobile device 1400.

In step 501, mobile device 105a detects a proximity to an access point to POS system 107a. For example, the mobile device 105a captures, using camera 1403, a quick response (QR) code indicating a request (and credentials) to connect to an access point of POS system 107a. As previously noted, the mobile device 105a may also detect the proximity as discussed with respect to step 301. Next, in step 503, the mobile device 105a establishes a link 103a to POS system 107a. As noted before, link 103a may be, for example, a WIFI connection, BLUETOOTH connection, a data connection utilizing data network 109, and the like. The mobile device 105a then transmits, in step 505, via the link 103a, an item indication determined by mobile device 105a. For instance, the mobile device 105a transmits an international standard book number (ISBN) (determined using camera 1403) via the link 103a. After transmission of the item indication, the mobile device 105a receives, as in step 507, via the link 103a, item information (e.g., price, availability, coupon, etc.) for an item indicated by the item indication. For example, mobile device 105a receives a price for a book corresponding to the transmitted ISBN from POS system 107a and a recommendation of other books by the author of the book. Next, in step 509, the mobile device 105a transmits, via the link 103a, authorization of payment of the price. For example, the mobile device 105a initiates an input of a pin authorizing payment of the price for the book, and transmits the pin, and payment information (e.g., credit card number) to POS system 107a.

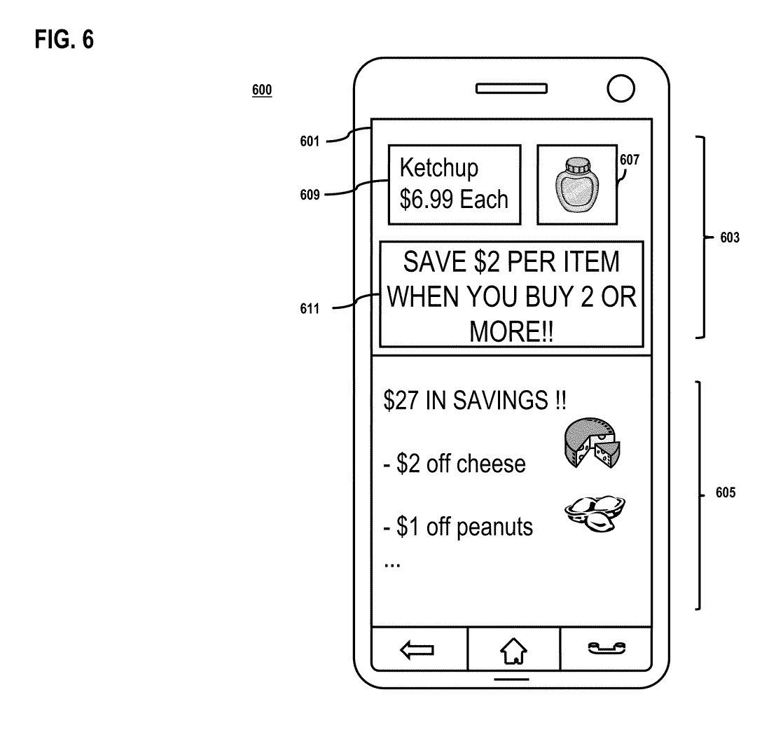

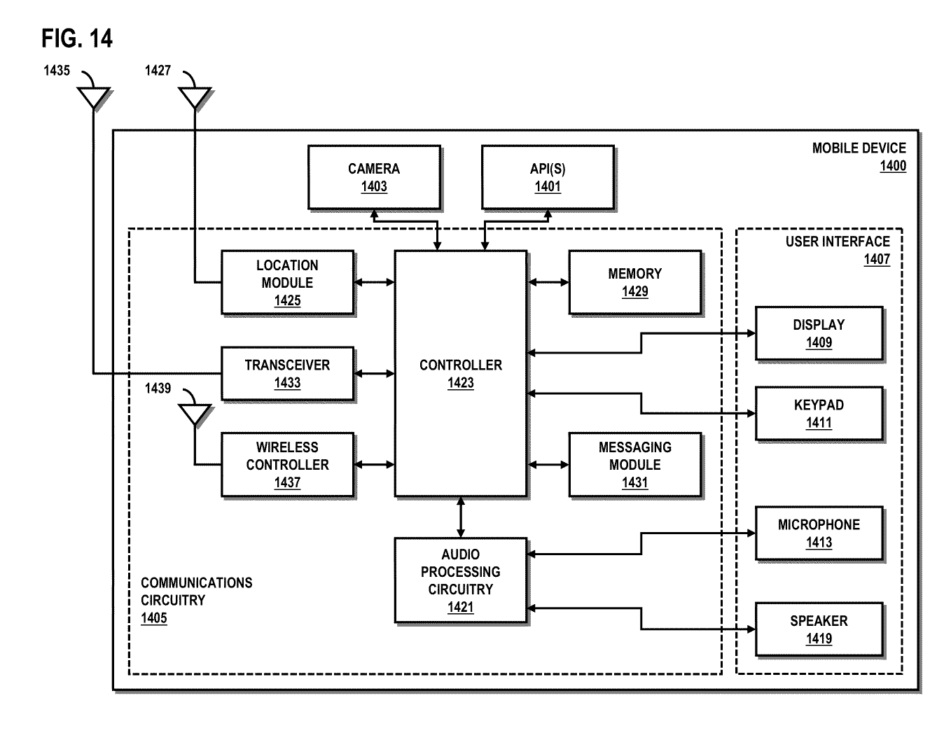

FIG. 6 is an illustration of one embodiment of a mobile device presenting a coupon (optionally included in item information) for an item based on item information determined by a cloud based POS platform, according to one embodiment. As illustrated, the mobile device 600 (such as described with respect to FIG. 14) presents a user interface 601 displaying first and second panes 603 and 605, respectively. The first pane 603 displays a picture 607 and name 609 of an item detected (shown as a ketchup bottle) along with coupon 611 for the item detected. The second pane 605 displays a real time summary of coupons applied to items in an index.

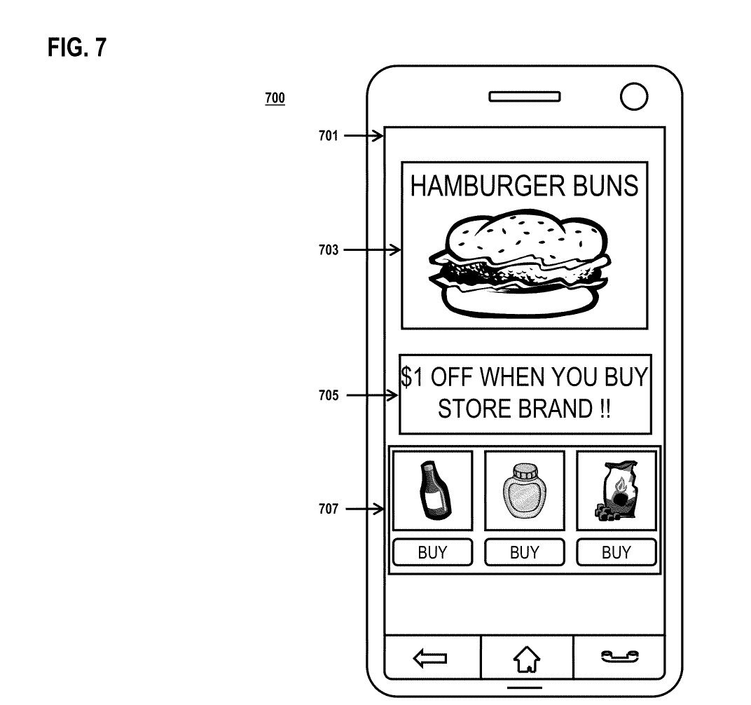

FIG. 7 is an illustration of one embodiment of a mobile device presenting advertisements (optionally included in item information) for an item using a cloud based POS platform, according to one embodiment. As illustrated, the mobile device 700 (such as described with respect to FIG. 14) presents a user interface 701 displaying a picture 703 of a detected item, a selectable option 705 to purchase a store brand item similar to the detected item, and selectable options 707 to select items to purchase related to the detected item.

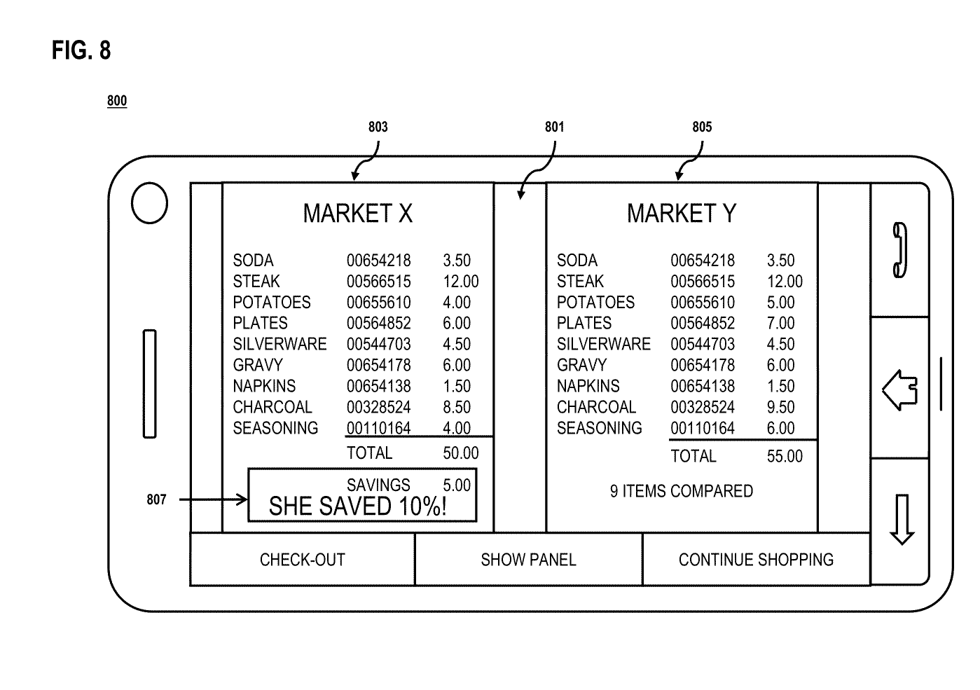

FIG. 8 is an illustration of one embodiment of a mobile device presenting prices for items at two retailers (optionally included in item information) using a cloud based POS platform, according to one embodiment. As illustrated, the mobile device 800 (such as described with respect to FIG. 14) presents a user interface 801 displaying first and second panes 803 and 805, respectively. The first pane 803 displays an index of items and corresponding prices for each item at a first retailer. The second pane 805 displays an index of the items displayed in the first pane and corresponding prices for each item at a second retailer. The first pane 803 further includes a total savings indicator 807 indicating a cumulative difference in the price of items in the index.

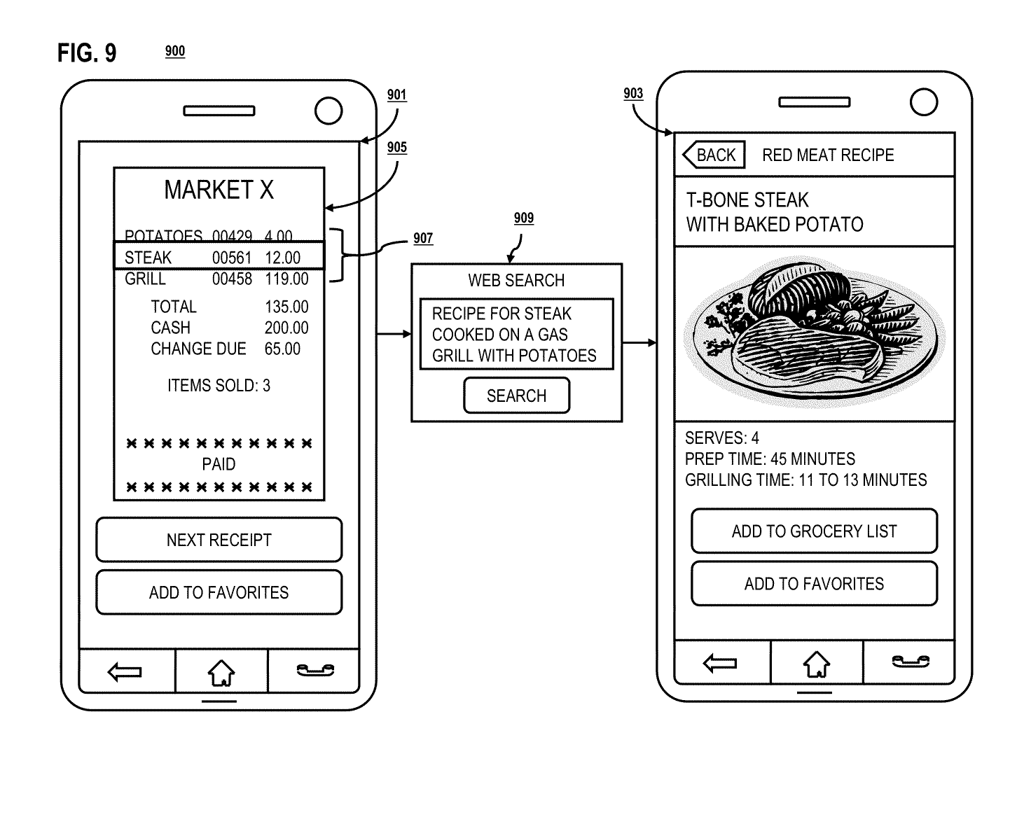

FIG. 9 is an illustration of one embodiment of a mobile device presenting a query result (optionally included in item information) for an item using a cloud based POS platform, according to one embodiment. As illustrated, the mobile device 900 (such as described with respect to FIG. 14) presents a user interface displaying first and second screens 901 and 903, respectively. The first screen 901 displays a selectable index 905 of item names 907 (e.g., steak) that when selected causes mobile device 900 to initiate web search 909 using one or more search terms associated with the item names 907. The web search 909 may be performed, for instance, using the one or more networks 109-115, and/or via the link 103. The second screen 903 then displays results (optionally included in item information) from the web search 909.

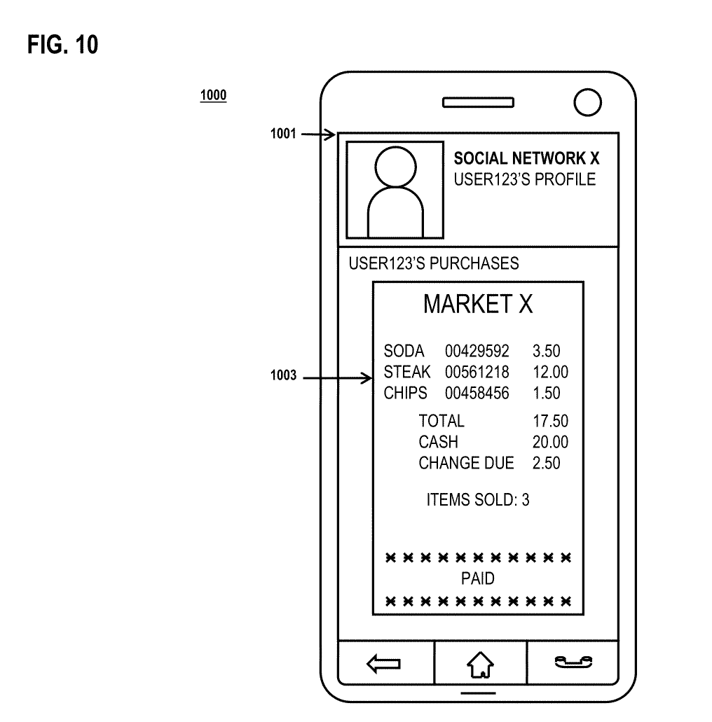

FIG. 10 is an illustration of one embodiment of a mobile device presenting an index using a cloud based POS platform, according to one embodiment. As illustrated, the mobile device 1000 (such as described with respect to FIG. 14) presents a user interface 1001 displaying a presentation of an index 1003 on a profile of a social networking platform. The social networking platform may be accessed for instance, using a web browser, an application for the social networking platform, and user interface 1001, by, for example, mobile devices 105, computing device 117, terminals 121, etc.

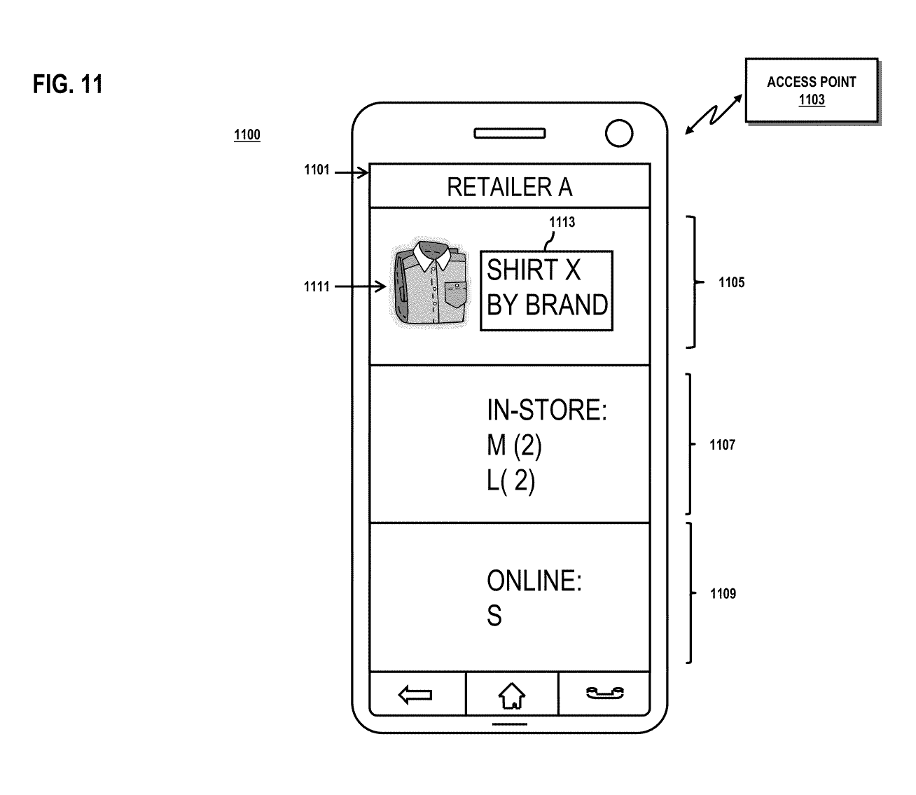

FIG. 11 is an illustration of one embodiment of a mobile device presenting an availability (optionally included in item information) of an item using a cloud based POS platform, according to one embodiment. As illustrated, the mobile device 1100 (such as described with respect to FIG. 14), connected to an access point 1103 at a first retailer location (or POS system 107a), presents a user interface 1101 displaying first, second, and third panes 1105, 1107, and 1109 respectively. The first pane 1105 displays a picture 1111 and name 1113 of an item type detected (shown as a shirt) at the first retailer location. An item type is optionally included in item information. The second pane 1107 displays a real time availability of the item type detected at the first retailer location. The third pane 1109 displays a real time availability of the item type detected at another retailer location, for example, a brick and mortar retailer location, an inventory warehouse of the retailer, an online processing center of the retailer, etc.

The processes for presenting item information before a checkout process described herein may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 12 is a diagram of a computer system that can be used to implement various exemplary embodiments. The computer system 1200 includes a bus 1201 or other communication mechanism for communicating information and one or more processors (of which one is shown) 1203 coupled to the bus 1201 for processing information. The computer system 1200 also includes main memory 1205, such as a random access memory (RAM) or other dynamic storage device, coupled to the bus 1201 for storing information and instructions to be executed by the processor 1203. Main memory 1205 can also be used for storing temporary variables or other intermediate information during execution of instructions by the processor 1203. The computer system 1200 may further include a read only memory (ROM) 1207 or other static storage device coupled to the bus 1201 for storing static information and instructions for the processor 1203. A storage device 1209, such as a magnetic disk, flash storage, or optical disk, is coupled to the bus 1201 for persistently storing information and instructions.

The computer system 1200 may be coupled via the bus 1201 to a display 1211, such as a cathode ray tube (CRT), liquid crystal display, active matrix display, or plasma display, for displaying information to a computer user. Additional output mechanisms may include haptics, audio, video, etc. An input device 1213, such as a keyboard including alphanumeric and other keys, is coupled to the bus 1201 for communicating information and command selections to the processor 1203. Another type of user input device is a cursor control 1215, such as a mouse, a trackball, touch screen, or cursor direction keys, for communicating direction information and command selections to the processor 1203 and for adjusting cursor movement on the display 1211.

According to an embodiment of the invention, the processes described herein are performed by the computer system 1200, in response to the processor 1203 executing an arrangement of instructions contained in main memory 1205. Such instructions can be read into main memory 1205 from another computer-readable medium, such as the storage device 1209. Execution of the arrangement of instructions contained in main memory 1205 causes the processor 1203 to perform the process steps described herein. One or more processors in a multi-processing arrangement may also be employed to execute the instructions contained in main memory 1205. In alternative embodiments, hard-wired circuitry may be used in place of or in combination with software instructions to implement the embodiment of the invention. Thus, embodiments of the invention are not limited to any specific combination of hardware circuitry and software.

The computer system 1200 also includes a communication interface 1217 coupled to bus 1201. The communication interface 1217 provides a two-way data communication coupling to a network link 1219 connected to a local network 1221. For example, the communication interface 1217 may be a digital subscriber line (DSL) card or modem, an integrated services digital network (ISDN) card, a cable modem, a telephone modem, or any other communication interface to provide a data communication connection to a corresponding type of communication line. As another example, communication interface 1217 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 1217 sends and receives electrical, electromagnetic, or optical signals that carry digital data streams representing various types of information. Further, the communication interface 1217 can include peripheral interface devices, such as a Universal Serial Bus (USB) interface, a PCMCIA (Personal Computer Memory Card International Association) interface, etc. Although a single communication interface 1217 is depicted in FIG. 12, multiple communication interfaces can also be employed.

The network link 1219 typically provides data communication through one or more networks to other data devices. For example, the network link 1219 may provide a connection through local network 1221 to a host computer 1223, which has connectivity to a network 1225 (e.g. a wide area network (WAN) or the global packet data communication network now commonly referred to as the “Internet”) or to data equipment operated by a service provider. The local network 1221 and the network 1225 both use electrical, electromagnetic, or optical signals to convey information and instructions. The signals through the various networks and the signals on the network link 1219 and through the communication interface 1217, which communicate digital data with the computer system 1200, are exemplary forms of carrier waves bearing the information and instructions.

The computer system 1200 can send messages and receive data, including program code, through the network(s), the network link 1219, and the communication interface 1217. In the Internet example, a server (not shown) might transmit requested code belonging to an application program for implementing an embodiment of the invention through the network 1225, the local network 1221 and the communication interface 1217. The processor 1203 may execute the transmitted code while being received and/or store the code in the storage device 1209, or other non-volatile storage for later execution. In this manner, the computer system 1200 may obtain application code in the form of a carrier wave.

The term “computer-readable medium” as used herein refers to any medium that participates in providing instructions to the processor 1203 for execution. Such a medium may take many forms, including but not limited to computer-readable storage medium ((or non-transitory)—e.g., non-volatile media and volatile media), and transmission media. Non-volatile media include, for example, optical or magnetic disks, such as the storage device 1209. Volatile media include dynamic memory, such as main memory 1205. Transmission media include coaxial cables, copper wire and fiber optics, including the wires that comprise the bus 1201. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 13 illustrates a chip set or chip 1300 upon which an embodiment of the invention may be implemented. Chip set 1300 is programmed to enable establishing a link between a POS system and mobile device as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1300 can be implemented in a single chip. It is further contemplated that in certain embodiments the chip set or chip 1300 can be implemented as a single “system on a chip.” It is further contemplated that in certain embodiments a separate ASIC would not be used, for example, and that all relevant functions as disclosed herein would be performed by a processor or processors. Chip set or chip 1300, or a portion thereof, constitutes a means for performing one or more steps of enabling an establishing of a link between a mobile device and a POS system.

In one embodiment, the chip set or chip 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1300 includes merely one or more processors and some software and/or firmware supporting and/or relating to and/or for the one or more processors.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to enable an establishing of a link between a mobile device and a POS system. The memory 1305 also stores the data associated with or generated by the execution of the inventive steps.

FIG. 14 is a diagram of a mobile device configured to facilitate a link with a POS system, according to one embodiment. Mobile device 1400 (e.g., equivalent to the mobile devices 105) may comprise computing hardware (such as described with respect to FIGS. 12 and 13), as well as include one or more components configured to execute the processes described herein for facilitating an establishing of a link between a mobile device and a POS system. In this example, mobile device 1400 includes application programming interface(s) 1401, camera 1403, communications circuitry 1405, and user interface 1407. While specific reference will be made hereto, it is contemplated that mobile device 1400 may embody many forms and include multiple and/or alternative components.

According to exemplary embodiments, user interface 1407 may include one or more displays 1409, keypads 1411, microphones 1413, and/or speakers 1419. Display 1409 provides a graphical user interface (GUI) that permits a user of mobile device 1400 to view dialed digits, call status, menu options, and other service information. Specifically, the display 1409 may allow viewing of, for example, a template. The GUI may include icons and menus, as well as other text and symbols. Keypad 1411 includes an alphanumeric keypad and may represent other input controls, such as one or more button controls, dials, joysticks, touch panels, etc. The user thus can construct templates, enter field values, initialize applications, select options from menu systems, and the like. Specifically, the keypad 1411 may enable the inputting of characters and words. Microphone 1413 coverts spoken utterances of a user (or other auditory sounds, e.g., environmental sounds) into electronic audio signals, whereas speaker 1419 converts audio signals into audible sounds or utterances. A camera 1403 may be used as an input device to detect images, for example a QR code.

Communications circuitry 1405 may include audio processing circuitry 1421, controller 1423, location module 1425 (such as a GPS receiver) coupled to antenna 1427, memory 1429, messaging module 1431, transceiver 1433 coupled to antenna 1435, and wireless controller 1437 coupled to antenna 1439. Memory 1429 may represent a hierarchy of memory, which may include both random access memory (RAM) and read-only memory (ROM). Computer program instructions and corresponding data for operation can be stored in non-volatile memory, such as erasable programmable read-only memory (EPROM), electrically erasable programmable read-only memory (EEPROM), and/or flash memory. Memory 1429 may be implemented as one or more discrete devices, stacked devices, or integrated with controller 1423. Memory 1429 may store information, such as contact lists, preference information, and the like. As previously noted, it is contemplated, that functions performed by platform 101 may be performed by the mobile device 1400.

Additionally, it is contemplated that mobile device 1400 may also include one or more applications and, thereby, may store (via memory 1429) data associated with these applications for providing users with browsing functions, business functions, calendar functions, communication functions, contact managing functions, data editing (e.g., database, word processing, spreadsheets, etc.) functions, financial functions, gaming functions, imaging functions, messaging (e.g., electronic mail, IM, MMS, SMS, etc.) functions, multimedia functions, service functions, storage functions, synchronization functions, task managing functions, querying functions, and the like. As such, signals received by mobile device 1400 from, for example, platform 101 may be utilized by API(s) 1401 and/or controller 1423 to facilitate the sharing of information, and improving the user experience.

Accordingly, controller 1423 controls the operation of mobile device 1400, such as in response to commands received from API(s) 1401 and/or data stored to memory 1429. Control functions may be implemented in a single controller or via multiple controllers. Suitable controllers 1423 may include, for example, both general purpose and special purpose controllers and digital signal processors. Controller 1423 may interface with audio processing circuitry 1421, which provides basic analog output signals to speaker 1419 and receives analog audio inputs from microphone 1413.

Mobile device 1400 also includes messaging module 1431 that is configured to receive, transmit, and/or process messages (e.g., enhanced messaging service (EMS) messages, SMS messages, MMS messages, instant messaging (IM) messages, electronic mail messages, and/or any other suitable message) received from (or transmitted to) platform 101 or any other suitable component or facility of system 100. As such, messaging module 1431 may be configured to receive, transmit, and/or process information shared by the mobile device 1400. For example, platform 101 can send an SMS information relating to a template, code word, and the like.

It is also noted that mobile device 1400 can be equipped with wireless controller 1437 to communicate with a wireless headset (not shown) or other wireless network. The headset can employ any number of standard radio technologies to communicate with wireless controller 1437; for example, the headset can be BLUETOOTH enabled. It is contemplated that other equivalent short range radio technology and protocols can be utilized. While mobile device 1400 has been described in accordance with the depicted embodiment of FIG. 14, it is contemplated that mobile device 1400 may embody many forms and include multiple and/or alternative components.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
determining, by a point-of-sale (POS) system, a proximity of a physical location of a mobile device to an access point associated with the POS system, wherein the mobile device is configured to connect to the access point and to initiate establishment of a communication session over a service provider network;
initiating a link, via the access point, between the mobile device and the POS system based on the determined proximity;
receiving, via the link, an indication of an item that includes a good, a service, or a combination thereof;
determining, by the POS system, item information for the item based on the indication; and
transmitting, via the link, the item information to the mobile device.

2. The method according to claim 1, comprising:
determining, by the POS system, an index indicating a plurality of items associated with the mobile device, wherein the item is indicated in the index; and
initiating a presentation of the index at the mobile device.

3. The method according to claim 2, comprising:
determining, by the POS system, item information for each of the items; and
transmitting, via the link, the item information for each of the items to the mobile device.

4. The method according to claim 2, wherein the index is determined based on a mobile device number (MDN) assigned to the mobile device by the service provider network.

5. The method according to claim 2, wherein the POS system is associated with a retailer and the item information includes an indication of a price for the item at the retailer, the method further comprising:
determining, by the POS system, an advertisement associated with at least one of the items for presentation at the mobile device;
determining, by the POS system, a data query associated with at least one of the items to obtain a query result for presentation at the mobile device;
determining, by the POS system, another price of at least one of the items at another retailer for presentation at the mobile device; and
initiating, by the POS system, a presentation of the advertisement, the query result, the another price, or a combination thereof at the mobile device.

6. The method according to claim 1, wherein the POS system is associated with a plurality of physical locations, the method further comprising:
determining an availability of the item at each of the physical locations; and
initiating a presentation of the availability at the mobile device.

7. An apparatus comprising:
at least one processor; and
at least one memory including computer program code for one or more programs,
the at least one memory and the computer program code configured to, with the at least one processor, cause the apparatus to perform at least the following,
determine a proximity of a physical location of a mobile device to an access point associated with the apparatus, wherein the mobile device is configured to connect to the access point and to initiate establishment of a communication session over a service provider network;
initiate a link, via the access point, with the mobile device based on the determined proximity;
receive, via the link, an indication of an item that includes a good, a service, or a combination thereof;
determine item information for the item based on the indication; and
transmit, via the link, the item information to the mobile device.

8. The apparatus according to claim 7, wherein the apparatus is further caused to:
determine an index indicating a plurality of items associated with the mobile device, wherein the item is indicated in the index; and
initiate a presentation of the index at the mobile device.

9. The apparatus according to claim 8, wherein the apparatus is further caused to:
determine item information for each of the items; and
transmit, via the link, the item information for each of the items to the mobile device.

10. The apparatus according to claim 8, wherein the index is determined based on a mobile device number (MDN) assigned to the mobile device by the service provider network.

11. The apparatus according to claim 8, wherein the apparatus is point-of-sale (POS) system associated with a retailer and the item information includes an indication of a price for the item at the retailer, and the apparatus is further caused to:
determine an advertisement associated with at least one of the items for presentation at the mobile device;
determine a data query associated with at least one of the items to obtain a query result for presentation at the mobile device;
determine another price of at least one of the items at another retailer for presentation at the mobile device; and
initiate a presentation of the advertisement, the query result, the another price, or a combination thereof.

12. The apparatus according to claim 7, wherein the apparatus is a POS system associated with a plurality of physical locations, the apparatus further caused to:
determine an availability of the item at each of the physical locations; and
initiate a presentation of the availability at the mobile device.

13. A method comprising:
determining, by a mobile device, a physical proximity of the mobile device to an access point associated with a point-of-sale (POS) system, wherein the mobile device is configured to connect to the access point and to initiate establishment of a communication session over a service provider network;
initiating a link, via the access point, between the mobile device and the POS system based on the physical proximity;
determining, by the mobile device, an item indication of an item that includes a good, a service, or a combination thereof; and
transmitting, via the link, the item indication to the POS system.

14. The method according to claim 13, comprising:
detecting an image of the item, an electronic token indicating the item, or a combination thereof, wherein the item indication is determined based on the image, the electronic token, or a combination thereof.

15. The method according to claim 13, comprising:
determining a geolocation of the mobile device; and
determining a geolocation associated with the POS system, wherein the physical proximity is based on the geolocation of the mobile device and the geolocation associated with the POS system.

16. The method according to claim 13, comprising:
receiving, by the mobile device, a request transmitted from the access point, wherein the physical proximity is based on the reception of the request.

17. The method according to claim 13, comprising:
receiving, via the link, a price for the item at the mobile device; and
transmitting, via the link, authorization of payment of the price for the item from the mobile device.

18. An apparatus comprising:
at least one processor; and
at least one memory including computer program code for one or more programs,
the at least one memory and the computer program code configured to, with the at least one processor, cause the apparatus to perform at least the following,
determine a physical proximity of the apparatus to an access point associated with a point-of-sale (POS) system, wherein the apparatus is configured to connect to the access point and to initiate establishment of a communication session over a service provider network;
initiate a link, via the access point, between the apparatus and the POS system based on the determined physical proximity;
determine an item indication of an item that includes a good, a service, or a combination thereof; and
transmit, via the link, the item indication to the POS system.

19. The apparatus according to claim 18, wherein the apparatus is further caused to:
detect an image of the item, an electronic token indicating the item, or a combination thereof, wherein the item indication is determined based on the image, the electronic token, or a combination thereof.

20. The apparatus according to claim 18, wherein the apparatus is further caused to:
determine a geolocation of the apparatus; and
determine a geolocation associated with the POS system, wherein the physical proximity is based on the geolocation of the apparatus and the geolocation associated with the POS system.

21. The apparatus according to claim 18, wherein the apparatus is further caused to:
receive a request transmitted from the access point, wherein the physical proximity is based on the reception of the request.

22. The apparatus according to claim 18, wherein the apparatus is further caused to:
receiving, via the link, a price for the item at the apparatus; and
transmitting, via the link, authorization of payment of the price for the item from the apparatus.
